(19) United States
(12) Patent Application Publication
(10) Pub. No.: US 2026/0297292 A1
(43) Pub. Date: Oct. 1, 2026

(54) SWITCHABLE THERMAL INTERFACE MATERIALS

(71) Applicant: LORD CORPORATION, Cary, NC (US)

(72) Inventors: Timothy D. Fornes, Apex, NC (US); Anthony T. MOLE, Raleigh, NC (US)

(73) Assignee: LORD CORPORATION, Cary, NC (US)

(21) Appl. No.: 19/479,814

(22) PCT Filed: May 31, 2024
(86) PCT No.: PCT/US2024/031868

§ 371 Date: Oct. 29, 2025

Related U.S. Application Data
(60) Provisional application No. 63/470,363, filed on Jun. 1, 2023.

(51) Int. Cl. C08K 3/08; C08G 71/04; C08G 77/20; C08K 3/22; C08K 3/26; C08K 7/16; C09K 5/16; H01M 10/653

(52) U.S. Cl. CPC C08K 3/08; C08G 71/04; C08G 77/20; C08K 3/22; C08K 3/26; C08K 7/16; C09K 5/16; H01M 10/653; C08K 2003/0812; C08K 2003/2227; C08K 2003/2296; C08K 2003/265

(57) ABSTRACT

Thermal interface materials and compositions. The thermal interface materials are thermally conductive at a first temperature range, but reduce thermal conductivity at a second or higher temperature range. Methods of controlling thermal load of a battery or mitigating thermal runaway in a battery, including using the disclosed thermal interface materials, are provided.

### PRIORITY CLAIM

The present application claims priority to U.S. Provisional Patent Application Ser. No. 63/470,363, filed Jun. 1, 2023, the disclosure of which is incorporated herein by reference in its entirety.

### TECHNICAL FIELD

The presently disclosed subject matter relates to switchable thermal interface materials. Exemplary thermal interface material compositions include a 2-component thermosetting matrix and a conductive filler, where the thermal interface material is thermally conductive at a first temperature range, and the thermal conductivity of the thermal interface material substantially decreases at a second temperature range.

### BACKGROUND

Many industrial applications require thermal interface materials (TIM) or thermal barrier insulation materials to act as thermal conductors and/or to control thermal loads. In one particular non-limiting example there is a need for thermal runaway mitigation of batteries used in electric vehicle applications. Current battery pack assemblies rely heavily on thermal interface materials to efficiently transmit heat from the batteries to battery module casings and from the casings to cooling plates. However, this arrangement becomes problematic when a battery cell catches on fire. Specifically, heat can bypass the thermal barrier insulation between cells via the conductive pathway established by the TIM materials. With enough heat, temperatures of adjacent cells can exceed the melting point of the battery's polymer cathode-anode separator; this, in turn, triggers thermal runaway of the adjacent cell.

Accordingly, there remains an unmet need for a TIM material that efficiently conducts heat under normal operating conditions yet dramatically drops its conductivity well before the melting point of the polymer separator. That is, a material that switches from a conductor to an insulator at a desired temperature. Such switchable thermal interface materials are provided herein.

### SUMMARY

This summary lists several embodiments of the presently disclosed subject matter, and in many cases lists variations and permutations of these embodiments. This summary is merely an example of the numerous and varied embodiments. Mention of one or more representative features of a given embodiment is likewise for purposes of example. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

Disclosed herein are thermal interface material composition, comprising a two-component thermosetting matrix, wherein the two-component thermosetting matrix comprises a first component and a second component, and a thermally conductive filler. In some embodiments, the thermal interface material is thermally conductive at a first temperature range, wherein the thermal conductivity of the thermal interface material substantially decreases at a second temperature range.

In some embodiments, the first component comprises a resin capable of reacting when in contact with the second component and optionally comprises a thermally conductive filler. In some embodiments, the first component comprises an isocyanate resin capable of reacting when in contact with the second component, and optionally comprises a thermally conductive filler. In some embodiments, the first component comprises a vinyl functional silicone resin and an addition cure catalyst capable of reacting when in contact with the second component, and optionally comprises a thermally conductive filler. In some embodiments, the first component comprises an epoxy resin capable of reacting when in contact with the second component, and optionally comprises a thermally conductive filler. In some embodiments, the first component comprises an acrylic resin capable of reacting when in contact with the second component, and optionally comprises a thermally conductive filler.

In some embodiments, the second component comprises a compound capable of reacting with and/or initiating a polymerization of the reactive resin of the first component. In some embodiments, the second component comprises an isocyanate reactive compound capable of reacting with the composition of the first component. In some embodiments, the second component comprises a hydride functional silicone resin capable of reacting with the composition of the first component. In some embodiments, the second component comprises an epoxy reactive compound or catalyst capable of reacting with and/or initiating the polymerization of the epoxy resin of the first component. In some embodiments, the second component comprises an initiator capable of polymerizing the composition of the first component.

In some embodiments, the first and second components are configured to be mixed to react to form a thermal interface matrix.

In some embodiments, the first temperature range is from about −40° C. to about 80° C., wherein the second temperature range is from about 80° C. to about 200° C., optionally wherein the first temperature range is from about −40° C. to about 160° C., wherein the second temperature range is from about 160° C. to about 250° C. In some embodiments, the thermal interface material decreases thermal conductivity, optionally decreased by at least about 30%, about 50%, about 75%, about 90%, about 95%, about 99%, or more. In some embodiments, the thermal interface material decreases in apparent conductivity, and/or increases interfacial resistance. In some embodiments, the apparent conductivity of the thermal interface material, upon exposure to the second temperature range, decreases by at least about 50%, about 75%, about 80%, about 90%, about 95%, about 99%, or more.

In some embodiments, the disclosed thermal interface materials further comprise a constituent capable of decomposing and/or changing phase at elevated temperature thereby reducing an apparent conductivity of the thermal interface material. In some embodiments, the conductive filler comprises aluminum trihydrate (ATH).

In some embodiments, the disclosed thermal interface materials further comprise expandable polymeric microspheres.

Also disclosed herein are methods of making a thermal interface material, comprising mixing the first component with the second component.

These and other objects are achieved in whole or in part by the presently disclosed subject matter. Other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following, example figure. The components in the figure are not necessarily to scale, emphasis instead being placed upon illustrating the principles of the presently disclosed subject matter (often schematically). In the figure, like reference numerals designate corresponding parts throughout the different views. A further understanding of the presently disclosed subject matter can be obtained by reference to an embodiment set forth in the illustrations of the accompanying drawing. Although the illustrated embodiment is merely for purposes of example of systems for carrying out the presently disclosed subject matter, both the organization and method of operation of the presently disclosed subject matter, in general, together with further objectives and advantages thereof, may be more easily understood by reference to the drawings and the following description. The drawing is not intended to limit the scope of this presently disclosed subject matter, which is set forth with particularity in the claims as appended or as subsequently amended, but merely to clarify and provide examples of the presently disclosed subject matter.

For a more complete understanding of the presently disclosed subject matter, reference is now made to the following drawing in which:

FIG. 1 Illustration of undesirable propagation of heat via battery cell-Conventional TIM-Cold Plate assembly during thermal event in current battery assemblies.

FIG. 2 Illustration of switchable TIM concept that blocks/limits conductive heat transfer at elevated temperatures.

FIG. 3 The effect of exposure temperature on the bulk thermal conductivity of samples based on a conventional and switchable TIM technologies based on formulations listed in Tables 1-4.

FIG. 4 The effect of exposure temperature on the bulk thermal conductivity for TIMs of Tables 4 and 5 based on expandable microspheres (120° C. onset temperature) of varying concentration and Table 1 based on the conventional TIM.

FIG. 5 The effect of exposure temperature on the bulk thermal conductivity for the TIMs of Tables 6-8.

FIG. 6 The effect of exposure temperature on the bulk thermal conductivity for the TIMs of Tables 9-11.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The term “thermal conductivity” is used herein to refer to the measure of a material's ability to conduct heat. In the context of a TIM, the heat transfer from one interface to another is a function of the thermal conductivity (also referred to as “bulk conductivity”) of the TIM, itself, as well as the interfacial resistances between TIM and the connecting interfaces, respectively. Furthermore, it is understood in the art that the term “apparent conductivity” is used to describe a TIM's ability to conduct heat from one interface to another for a given bond line thickness that bridges the interfaces and thus takes into account the TIM's thermal conductivity and the resistances of the TIM-substrate interfaces. For the sake of the present invention, the switchable TIM may change the apparent thermal conductivity by not only affecting the bulk thermal conductivity for the material, but also increase the thickness of the TIM and/or the interfacial resistances of TIM-substrate interfaces.

The terms “epoxy”, “epoxide” and “oxirane” as used herein refer to chemical functional group comprising a three-membered ring structure comprising one oxygen atom and two carbon atoms that are bonded together via single bonds. Thus, an epoxy group can have the structure:

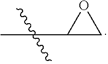 [SMILES: *C1CO1]

The term “silyl” refers to groups comprising silicon atoms (Si).

The term “silane” refers to a molecule comprising a silicone atom.

As used herein, the terms “siloxy” and “silyl ether” refer to groups or compounds including a silicon-oxygen (Si—OR) bond and wherein R is an organic group, such as a substituted or unsubstituted alkyl or aryl group (i.e., methyl, ethyl, phenyl, etc.). In some embodiments, the terms refer to compounds comprising one, two, three, or four alkoxy, aralkoxy, or aryloxy groups bonded to a silicon atom. Each alkyloxy, aralkoxy, or aryloxy group can be the same or different.

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer.

An “epoxy” resin can be monofunctional, difunctional, multifunctional, or combinations thereof as long as the resulting material blend is liquid-like in nature at room temperature. The epoxy may be aliphatic, cycloaliphatic, aromatic, or the like. The “average” number of epoxy groups per molecule is determined by dividing the total number of epoxy groups in the epoxy-containing material by the total number of epoxy molecules present. Useful epoxy materials generally contain on the average at least 1.5 polymerizable epoxy groups per molecule. Preferably two or more epoxy groups per molecule are present. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds but are generally mixtures containing one, two, or more epoxy groups per molecule.

The epoxy-containing materials may vary from low molecular weight monomeric materials to high molecular weight polymers and may vary greatly in the nature of their backbone and substituents groups. For example, the backbone may be of any type and substituents groups thereon being free of an active hydrogen atom. Illustrative of permissible substituents groups include halogens, ester groups, ethers, sulfonate groups, siloxane groups, nitro groups, phosphate groups, etc. The molecular weight of the epoxy-containing materials may vary from about 50 to 100,000 or more. Mixtures of various epoxy-containing materials can also be used in the compositions of this invention.

In a preferred embodiment the epoxy resin comprises liquid epoxy resins based on diglycidyl ether of bisphenol A (DGEBA) or diglycidyl ether of bisphenol-F (DGEBF). Liquid epoxy resins typically comprise a molecular weight of less than about 500 Daltons and preferably between about 150 and 600 Daltons. A preferred method for determining molecular weight is gel permeation (or size exclusion) chromatography.

In some embodiments, a resin matrix can comprise a “silicone” material, compound or resin. Silicone resins are a type of silicone material which is formed by branched, cage-like oligosiloxanes. Silicone resins are prepared by hydrolytic condensation of various silicone precursors. Silicone resins represent a broad range of products, including those having a molecular weight in the range of 1000-10,000 which are useful in adhesives, silicone rubbers, coatings and additives. Polysiloxane polymers with reactive side group functionality such as vinyl, acrylate, epoxy, mercaptan or amine, are used to create thermoset polymer matrix composites, coatings and adhesives.

In some aspects, use of a silicon in the disclosed compositions involves an addition reaction between the vinylsilyl group (Si—CH:CH2) and the hydrosilyl group (Si—H). Addition reactions are used in a wide range of applications including compounds such as silane coupling agents, and the curing reactions of silicones. With addition reactions, both room-temperature-curing and heat-curing are possible, and curing can occur in either open or hermetic conditions. These are a few of the distinctive features of addition reactions. And because addition reactions generate no by-products, the cured material exhibits heat resistance in enclosed spaces.

Silicone fluids suitable for use in embodiments of the present disclosure include silicones having reactive functional groups either pendent to or at the end of the siloxane polymer backbone, e.g. epoxides, amines, hydride, vinyl, hydroxyl, isocyanate, mercapto, carbinol, etc.; vinyl functional silicones having vinyl terminated functionality and/or vinyl groups pendent from the siloxane backbone; siloxane backbones can consist of silicone fluids listed above; vinyl T-structure polymers; and/or hydride functional polymers having hydride terminated and/or hydride groups pendent from the siloxane backbone.

A resin matrix component can comprise an “acrylic” material containing at least one acrylate and/or methacrylate functional group. The acrylic resin can be monofunctional, difunctional, multifunctional, or combinations thereof as long as the resulting material blend is liquid-like in nature at room temperature. Representative monofunctional acrylic resins comprise esters of (meth)acrylic acid such as methyl methacrylate, ethyl methacrylate, butyl methacrylate, methyl acrylate, butyl acrylate, cyclohexyl acrylate, hexyl acrylate, 2-ethyl hexyl acrylate, lauryl acrylate, ethyl acrylate, dicyclopentadienyloxyethyl meth acrylate, cyclohexyl methacrylate, lauryl methacrylate, glycidyl methacrylate and tetrahydrofurfuryl methacrylate (THFMA). Other monofunctional resins include OH-functional monoethylenic unsaturated monomers like 3-hydroxypropyl (meth)acrylate, 4-hydroxy butyl (meth)acrylate, 4-hydroxycyclohexyl(meth) acrylate, 1,6-hexanediol mono(meth)acrylate, neopentyl glycol mono(meth)acrylate.

Representative resins comprising more than one functional group comprise epoxy dimethacrylates, epoxy diacrylates, urethane diacrylates, urethane dimethacrylates, glycol diacrylates, glycol dimethacrylates, trimethylolpropane diacrylate, trimethylolpropane dimethacrylates, polyester diacrylates, polyester dimethacrylates, cyclohexane diacrylates, cyclohexane dimethacrylates, trifunctional epoxy novolac acrylates, pentaerythritol tri acrylate, and dipentaerythritol pentaacrylate.

Resins can comprise a blend of aliphatic urethane diacrylate and a dipentaerythritol pentaacrylate. Resins can comprise a blend of bisphenol, a epoxy acrylate oligomer, a trifunctional epoxy novolac acrylate, and a trimethyl propane triacylate.

Furthermore, acrylic resins are known to undergo additions reactions (e.g. Michael addition reaction) or polymerize via free radicals. The former is a reaction between a nucleophile (Michael donors) and an activated olefin (e.g. an acrylate.) Common functional groups used as Michael donors include acetoacetates, amines, thiols and phosphines. In the case of free-radical polymerization of acrylics, an initiator is employed to generating free-radicals to induce polymerization. Common initiators are Without limitation, organic peroxides, such as benzoyl peroxide and other diacyl peroxides, hydroperoxides such as cumene hydroperoxide, peresters such as [3-butylperoxybenzoate; ketone hydroperoxides such as methylethyl ketone hydroperoxide, organic salts of transition metals such as cobalt naphthenate, and compounds containing a labile chlorine such as sulfonyl chloride. Furthermore, it is common to employ reducing agents (instead of heat for example), on the component containing the acrylic resin. The reducing agent, when combined with organic peroxides, can lead to initiation of the polymerization of the acrylic resin under ambient conditions. Representative reducing agents include, Without limitation, sulfnic acids; azo compounds such as azoisobutyric acid dinitrile; alpha-aminosulfones such as bis(tolysulfonmethyl)-benzyl amine; tertiary amines such as diisopropanol p-toluidine, diethanol-p-toluidine, dimethyl aniline, p-halogenated aniline derivatives and dimethyl-p-toluidine; and aminoaldehyde condensation products, for example, the condensation products of aliphatic aldehydes such as butyraldehyde with primary amines such as aniline or butylamine.

A resin matrix component can comprise an “isocyanate” material having at least two free isocyanate groups, including aliphatic, cycloaliphatic and aromatic compounds. Representative isocyanates include, without limitation, 2,4-toluene diisocyanate, 2,6-toluene diisocyanate, methylene diphenyl diisocyanates such as 2,4′-diphenylmethane diisocyanate, 4,4′-diphenylmethane diisocyanate, m- and p-phenylene diisocyanate, polymethylene poly(phenyl isocyanate), hexamethylene diisocyanate, 4,4′-methlenebis(cyclohexyl isocyanate), isophorone diisocyanate, and other aliphatic, heterocyclic and aromatic polyisocyanates, and including mixtures of such polyisocyanates.

Isocyanates are reactive toward a variety of nucleophiles including alcohols, amines, and even water having a higher reactivity compared to structurally analogous isothiocyanates. Examples include, but are not limited to a those molecules selected from the group consisting of a polyether, polyester, and aliphatic hydrocarbon. Additionally, isocyanate reactive resins can include those with at least two active hydrogen atoms that are selected from the group consisting of a hydroxyl, primary amine, secondary amine, thiol, urethane, urea, carboxylic acid, amide, and water.

As used herein, the term “room temperature” is considered to be any temperature between about 15° C. and about 25° C. (i.e., about 15, 16, 17, 18, 19, 20, 21, 22, 23, 24, or about 25° C.). In some embodiments, the term “room temperature” is a temperature between about 18° C. and about 24° C. or between about 20° C. and about 25° C.

Although not essential to the core aspect of the invention, the following items are common components used in 2-component (2K) formulations for controlling such properties as rheology, flammability, adhesion, incoming water level from the raw materials, among other things. Such common components may consist of, but no limited to, flame retardants, viscosity reducing additives, shear thinning additives, adhesion promoters, moisture scavengers, and plasticizers. Such materials, being non-essential to the inherent invention, have been denoted “additive package” herein.

### II. Switchable Thermal Interface Materials

The presently disclosed subject matter is directed to TIMs that are capable of dramatically reducing their ability to conduct heat when heated to elevated temperatures. To elaborate, such switchable or transformable TIMs are in some embodiments capable of dramatic changes in bulk conductivity, interfacial resistance, and/or morphology at a predetermined temperature. At least two principal routes to achieving this phenomenon are disclosed and demonstrated herein.

In first embodiment, a switchable TIM formulation comprises the incorporation of expandable polymeric microspheres in a thermally conductive formulation. In some aspects, the microspheres, when heated, expand many times beyond their original volume, thereby creating foam-like structures having inherently lower conductivity. Moreover, the expansion can in some embodiments cause full-, if not, partial-delamination of the TIM at elevated temperatures which leads to further resistance to heat transfer across the interface.

In a second embodiment, a switchable TIM formulation comprises constituents known to decompose and/or change phases at elevated temperature thereby reducing the formulation's apparent conductivity due to changes in the bulk conductivity of the composition, increases in interfacial resistances, and/or increases the bond line thickness of the TIM. More specifically, certain thermally conductive fillers such as, but not limited to, aluminum trihydrate (ATH) will decompose at elevated temperatures to produce water vapor and their respective oxides. The water vapor can subsequently expand and/or diffuse out of the matrix thereby creating a foam-like structure having inherently lower conductivity. Moreover, the morphological change can in some embodiments cause full-, if not, partial-delamination of the TIM at elevated temperatures which leads to further resistance to heat transfer across the interface.

In a third embodiment the combination of these first two embodiments can produce an even larger drop in conductivity and/or increase in interfacial resistance once a predetermined elevated temperature is reached.

Accordingly, as used herein a “switchable TIM” or “transformable TIM” includes any TIM that functions as a thermal conductor under a first temperature range, but changes functionality, including a reduction in conductivity, a reduction in interfacial resistance, and/or a morphological change, at a second or elevated temperature.

More particularly, in some embodiments, provided are thermal interface material compositions comprising a two-component thermosetting matrix, wherein the two-component thermosetting matrix comprises a first component and a second component, and a thermally conductive filler. In some aspects, the thermal interface material is thermally conductive at a first temperature range, wherein the thermal conductivity of the thermal interface material substantially decreases at a second temperature range.

The first component can include a resin capable of reacting when in contact with the second component and optionally comprises a thermally conductive filler.

In another embodiment, the first component comprises an isocyanate resin capable of reacting when in contact with the second component, and optionally comprises a thermally conductive filler.

In yet another embodiment, the first component comprises a vinyl functional silicone resin and an addition cure catalyst capable of reacting when in contact with the second component, and optionally comprises a thermally conductive filler.

In another embodiment, the first component comprises an epoxy resin capable of reacting when in contact with the second component, and optionally comprises a thermally conductive filler.

Finally, in another embodiment, the first component comprises an acrylic resin capable of reacting when in contact with the second component, and optionally comprises a thermally conductive filler.

Turning now to the second component, in some embodiments the second component comprises a compound capable of reacting with and/or initiating a polymerization of the reactive resin of the first component. This embodiment can be coupled with the embodiment where the first component can include a resin capable of reacting when in contact with the second component and optionally comprises a thermally conductive filler, as noted above.

In another embodiment, the second component comprises an isocyanate reactive compound capable of reacting with the composition of the first component. In some embodiments, this can be coupled with the first component that comprises an isocyanate resin as noted above.

In another embodiment, the second component can comprise a hydride functional silicone resin capable of reacting with the composition of the first component. This embodiment can be coupled with the embodiment where the first component comprises a vinyl functional silicone resin and an addition cure catalyst capable of reacting when in contact with the second component, and optionally comprises a thermally conductive filler.

In another embodiment, the second component comprises an epoxy reactive compound or catalyst capable of reacting with and/or initiating the polymerization of the epoxy resin component.

In yet another embodiment, the second component comprises an initiator capable of polymerizing the composition of the first component. Such an embodiment can be coupled with the embodiment where the first component comprises an acrylic resin capable of reacting when in contact with the second component, and optionally comprises a thermally conductive filler.

In some embodiments, the first and second components are configured to be mixed to react to form a thermal interface matrix.

As noted herein, the disclosed switchable TIMs are configured to function as a thermal conductor under a first temperature range, but then change functionality, including a reduction in conductivity, a reduction in interfacial resistance, and/or a morphological change, at a second or elevated temperature. The first temperature range can in some embodiments, and some applications, be from about −40° C. to about 80° C., wherein the second temperature range is from about 80° C. to about 200° C. Alternatively, the first temperature range can be from about −40° C. to about 100° C., wherein the second temperature range is from about 100° C. to about 250° C. Alternatively, the first temperature range can be from about −40° C. to about 120° C., wherein the second temperature range is from about 120° C. to about 250° C. Alternatively, the first temperature range can be from about −40° C. to about 160° C., wherein the second temperature range is from about 160° C. to about 250° C.

Based on the above switchable TIM properties, the thermal interface material can decrease thermal conductivity, optionally decreased by at least about 30%, about 50%, about 75%, about 90%, about 95%, about 99%, or more. In some aspects, the decrease in thermal conductivity is about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%.

Additionally, the thermal interface material can decrease thermal conductivity, increase interfacial resistance, or a combination of both.

The thermal conductivity of the thermal interface material, upon exposure to the second temperature range, can decreases by at least about 50%, about 75%, about 80%, about 90%, about 95%, about 99%, or more. In some aspects, the decrease in thermal conductivity, upon exposure to the second temperature range, is about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%.

Regarding the conductive filler, while any suitable filler can be used, in some preferred embodiments the conductive filler can comprise ATH. Other suitable fillers include, but are note restricted to aluminum, aluminum nitride, aluminum oxide (or alumina), ATH, beryllium oxide, boron nitride, carbon black, calcium carbonate, cobalt, copper, graphite, iron, magnesium oxide (or magnesia), magnesium hydroxide, nickel, silicon carbide, silicon dioxide (or silica), silver, silver-coated copper, talc, titanium dioxide, and zinc oxide.

The thermal interface material composition can in some aspects further comprise expandable polymeric microspheres. In some aspects, the microspheres, when heated, expand many times beyond their original volume, thereby creating foam-like structures having inherently lower conductivity. Moreover, the expansion can in some embodiments cause full-, if not, partial-delamination of the TIM at elevated temperatures which leads to further resistance to heat transfer across the interface.

The presently disclosed switchable TIMs are applicable to any industrial application where there is a need for a thermally conductive material under normal operating conditions, but which must transform or switch functionality when conditions are abnormal or outside of a desired temperature range. Such a switchable TIM can provide an advantageous changing functionality with the change in temperature or conditions; an advantage suitable in any number of industrial or commercial applications.

Although not limited to such an application, the presently disclosed subject matter is especially suited for and beneficial to electric vehicle (EV) applications, particularly to help prevent and/or mitigate catastrophic thermal runaway of battery cells. Switchable TIMs would permit the desired heat transmission and thermal conductivity (TC) to and from the battery during normal operating conditions (e.g. −40° C. to 80° C.); however, would dramatically drop in TC when one cell catches on fire. This change, triggered at temperatures as low as about 80° C., would help greatly reduce transmission of conductive heat to adjacent cells and thus help prevent the propagation of the fire. Thus, in some embodiments, wherein the first temperature range, or normal operating conditions, can range from about −40° C. to about 80° C., and the second temperature range, i.e. when a cell catches fire, is from about 80° C. to about 200° C., optionally wherein the first temperature range is from about −40° C. to about 160° C., wherein the second temperature range is from about 160° C. to about 250° C.

In a further embodiment, the presently disclosed subject matter may be suited for use in electronic components to help reduce or prevent the damage to the device itself and/or to the device's surroundings due to excessive heat transfer normally encountered with conventional TIMs. Examples of electronic components include, but are not limited to power conversion systems, inductors, transformers, inverters, electrical chokes, AC filters, thermistors, transistors, microprocessor chips, heat spreaders, heat sinks, thermally conductive underfills for flip chip applications, chargers, control modules, printed circuit boards, electrical switches, and electrical motors.

In some embodiments, the disclosed switchable TIMs can exist in the form of a potting compound, encapsulant, grease, gel, gap filler, adhesive, tape, pad, a coating. In a further embodiment, the said coating is pre-applied to a substrate (e.g. dielectric coating) that is to be later bonded by another TIM or traditional adhesive to another substrate.

In addition, in some embodiments, the disclosed formulations can assist in the removal of batteries during service or end-of-life disassembly/recycling. In another embodiment, it can assist in the disassembly, removal, recycling of electronic components and assemblies.

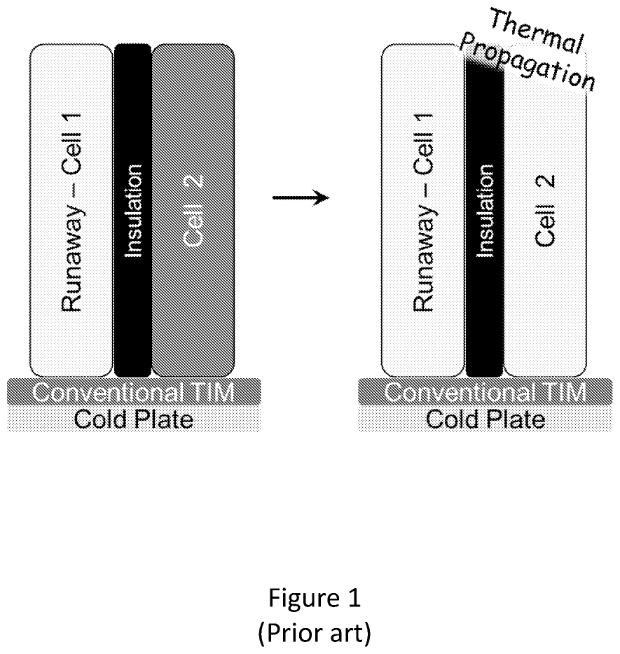

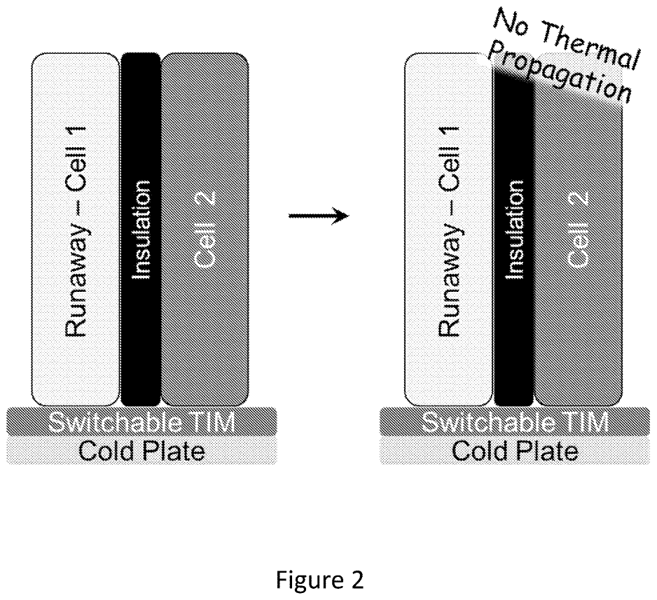

To elaborate, in some embodiments materials and methods are provided for thermal runaway mitigation of batteries used in EV applications. Current battery pack assemblies rely heavily on thermal interface materials to efficiently transmit heat from the batteries to battery module casings and from the casings to cooling plates. However, this becomes problematic when a battery cell catches fire as illustrated in FIG. 1. Specifically, heat can bypass the thermal barrier insulation between cells via the conductive pathway established by the TIM materials. With enough heat, temperatures of adjacent cells can exceed the melting point of the battery's polymer cathode-anode separator; this, in turn, triggers thermal runaway of the adjacent cell. As such, the presently disclosed subject matter provides a TIM material that efficiently conducts heat under normal operating conditions (e.g. −40° C. to about 80° C.), yet dramatically drops its conductivity well before the melting point of the polymer separator, (e.g., about 135° C.) as illustrated in FIG. 2. Thus, in some embodiments, wherein the first temperature range, or normal operating conditions of a batter in an EV application, can range from about −40° C. to about 80° C., and the second temperature range, i.e. when a cell of a battery in an EV application catches fire, is from about 80° C. to about 200° C., optionally wherein the first temperature range is from about −40° C. to about 160° C., wherein the second temperature range is from about 160° C. to about 250° C.

The thermal interface material composition may also include where the microspheres, if present, expand upon exposure to the second temperature range, optionally where the microspheres expand at least about 5-fold, 10-fold, 50-fold, 100-fold or more, beyond an original volume.

In some embodiments, provided are methods of controlling thermal load of a battery or mitigating thermal runaway in a battery, the method includes providing a thermal interface material as disclosed herein, and applying the thermal interface material to a battery or positioning the thermal interface material proximate to a battery, where in the event of a thermal overload of the battery resulting in a temperature of at least 80° C. or more the conductivity of the thermal interface material will decrease by at least about 50%. In the event of a thermal overload of the battery resulting in a temperature of at least 80° C. or more the conductivity of the thermal interface material will decrease by at least about 30%, about 50%, about 75%, about 90%, about 95%, about 99%, or more. In the event of a thermal overload of the battery resulting in a temperature of at least 80° C. or more, the microspheres of the thermal interface material expand at least about 5-fold, about 10-fold, about 50-fold, about 100-fold or more, beyond an original volume of the microspheres. In the event of a thermal overload of the battery resulting in a temperature of at least 100° C. or more the thermal interface material substantially delaminates from the battery thereby reducing thermal conductivity. In some embodiments, the battery is for an electric vehicle.

Accordingly, in some aspects, provided herein is an electric vehicle battery thermal runaway mitigation system. Such a system can include an electric vehicle battery, and a thermal interface material as disclosed herein.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Materials and Methods for Examples 1-6

The series of 2-part (2K), 1:1 volumetric mix ratio, formulations set forth in Tables 1-11 provide three examples of conventional TIMs (Tables 1, 6, and 9) and eight illustrative examples of switchable TIMs (Tables 2-5, 7-8, and 10-11). All individual components were prepared and tested for bulk thermal conductivity per the following general procedure. Thermally conductive fillers were dried at 110° C. for at least 24 hours prior to using. Liquids and solids (expect for expandable microspheres) were placed in a cup and mixed using a DAC 800.2 VAC “Hauschild” mixer. The nominal mixing time was 90 seconds at 1000 rpm under vacuum. The sides of the container were then scraped down and recombined with the mixture. The formula was mixed again for nominally 90 seconds at 1000 rpm under vacuum. For components containing expandable microspheres, the expandable microspheres were added prior to the second mixing step. Individual components were paired with their respective reactive counterparts and then packed into 1:1 by volume cartridges.

Thermal conductivity measurements were measured on cured samples that was prepared by dispensing the components from cartridges equipped with a static mix tip to form ~3.2 cm diameter samples approximately 1.0 cm thick. The sample was allowed to cure either at room temperature for 24 hours or 50 C for 10 hours. Bulk thermal conductivity was measured according to ISO 22007-2 using a Hot Disk Transient Plane Source (Model 2500 S). To test the effect of exposure temperature on the thermal conductivity, samples were placed in a preheated oven for 1 hour at the desired set temperature, allowed to cool back to room temperature, and tested for thermal conductivity per ISO 22007-2.

### Example 1

### Conventional, 2 W/m·K Urethane TIM

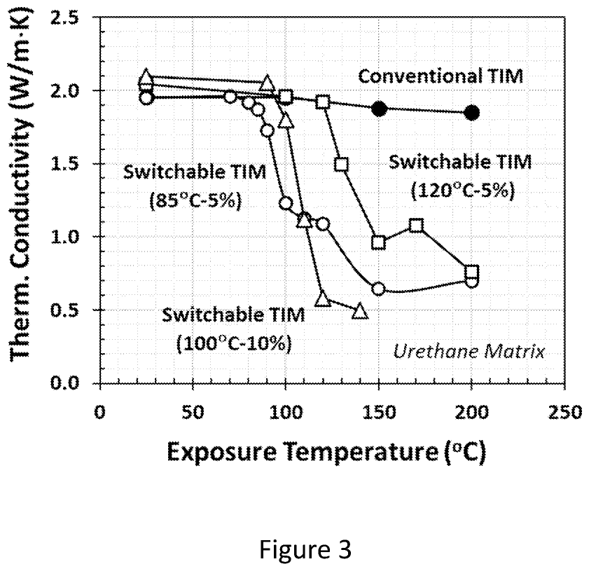

Table 1 lists ingredients of a conventional, thermally conductive, 2K urethane composition comprised of polyol and isocyanate containing components. The polyol containing component also contains thermally conductive aluminum oxide and aluminum trihydrate powders, whereas the isocyanate containing component contains aluminum oxide, aluminum trihydrate, and calcium carbonate powders. The combination of the two components when mixed at a volumetric mix ratio of 1:1 and cured produce a material with a bulk thermal conductivity of nominally 2 W/m·K. Exposure of the cured material to temperatures as high as 200° C. shows minimal change in thermal conductivity as seen FIG. 3.

TABLE 1

| | Wt % | Vol % |
|---|---|---|
| Polyol Containing Component | | |
| Polyol resin | 10.63 | 22.05 |
| Sn-based catalyst | 0.10 | 0.21 |
| Additive | 5.99 | 11.16 |
| Aluminum oxide powder | 18.44 | 9.99 |
| Aluminum trihydrate powder | 64.84 | 56.59 |
| Total | 100.00 | 100.00 |
| Isocyanate Containing Component | | |
| Isocyanate resin | 7.88 | 15.90 |
| Additive | 8.46 | 17.21 |
| Aluminum oxide powder | 18.13 | 10.03 |
| Aluminum trihydrate powder | 48.74 | 43.45 |
| Calcium carbonate powder | 16.79 | 13.42 |
| Total | 100.00 | 100.00 |

### Example 2

### Illustrative Examples, 2 W/m·K Switchable Urethane TIM

Tables 2-4 list ingredients of switchable TIMs based on thermally conductive, 2K urethane compositions. The polyol containing component for each TIM contains thermally conductive aluminum oxide, thermally conductive aluminum trihydrate, and expandable microsphere of varying type and concentration, whereas the isocyanate containing component contains aluminum trihydrate, aluminum oxide, and/or calcium carbonate powders. FIG. 3 shows the effect of exposure temperature on the bulk thermal conductivity for the switchable TIMs of Tables 2-4. Unlike the conventional TC urethane (Example 1), all three switchable TIM formulations show a large drop (i.e. >50%) in the thermal conductivity when heated to 200° C. Moreover, the exposure temperature at which the drop begins (onset temperature) is a function of the type of expandable microsphere used. In these examples the onset of thermal conductivity reduction ranges from nominally 85° C. to nominally 120° C. The concentration of microspheres shown in FIG. 3 is based on wt % microspheres in the organic content of the mixed formulation.

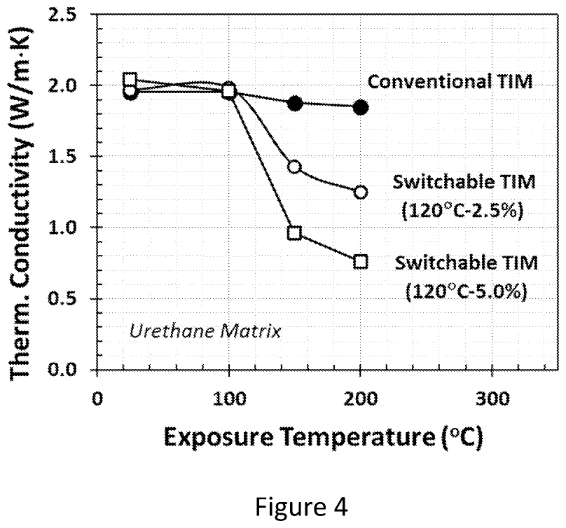

Table 5 lists ingredients of a switchable TIMs based on a thermally conductive, 2K urethane composition. The polyol containing component for each TIM contains thermally conductive aluminum oxide and expandable microspheres whose onset temperature for expansion is nominally 120° C. The concentration of microspheres is 2.5 wt % based on the organic content of the mixed formulation. The isocyanate containing component contains aluminum trihydrate and calcium carbonate powders and is identical to the isocyanate containing component in Table 4. FIG. 4 shows the effect of exposure temperature on the bulk thermal conductivity for the switchable TIMs in Tables 4 and 5 based on expandable microspheres (120° C. onset temperature) of varying concentration and Example 1 based on the conventional TIM. Unlike the conventional TIM, the switchable TIMs exhibit large decreases in thermal conductivity with temperature. The magnitude of the decrease is proportional to the concentration of expandable microspheres. Specifically, the switchable TIM of Table 4 based on 5.0 wt % expandable microspheres exhibits a ~63% drop in conductivity after 200° C. exposure versus a ~38% drop for the 2.5 wt % formulation (Table 5).

TABLE 2

| | Wt % | Vol % |
|---|---|---|
| Polyol Containing Component | | |
| Polyol resin | 11.04 | 21.47 |
| Sn-based catalyst | 0.10 | 0.19 |
| Additive | 4.96 | 8.21 |
| Expandable microspheres - 85° C. Onset | 1.50 | 2.70 |
| Aluminum trihydrate powder | 82.40 | 67.43 |
| Total | 100.0 | 100.0 |
| Isocyanate Containing Component | | |
| Isocyanate resin | 8.18 | 15.49 |
| Additive | 8.67 | 16.50 |
| Aluminum trihydrate powder | 64.96 | 54.37 |
| Calcium carbonate powder | 18.19 | 13.64 |
| Total | 100.00 | 100.00 |

TABLE 3

| | Wt % | Vol % |
|---|---|---|
| Polyol Containing Component | | |
| Polyol resin | 10.68 | 22.25 |
| Sn-based catalyst | 0.10 | 0.21 |
| Additive | 3.33 | 5.31 |
| Expandable microspheres - 100° C. Onset | 2.93 | 5.65 |
| Aluminum oxide powder | 18.37 | 9.99 |
| Aluminum trihydrate powder | 64.59 | 56.59 |
| Total | 100.00 | 100.00 |
| Isocyanate Containing Component | | |
| Isocyanate resin | 8.48 | 17.12 |
| Additive | 7.93 | 15.99 |
| Aluminum oxide powder | 18.12 | 10.03 |
| Aluminum trihydrate powder | 48.69 | 43.44 |
| Calcium carbonate powder | 16.78 | 13.42 |
| Total | 100.00 | 100.00 |

TABLE 4

| | Wt % | Vol % |
|---|---|---|
| Polyol Containing Component | | |
| Polyol resin | 10.63 | 22.10 |
| Sn-based catalyst | 0.10 | 0.21 |
| Additive | 4.70 | 8.31 |
| Expandable microspheres - 120° C. Onset | 1.45 | 2.79 |
| Aluminum oxide powder | 18.41 | 9.99 |
| Aluminum trihydrate powder | 64.71 | 56.60 |
| Total | 100.00 | 100.00 |
| Isocyanate Containing Component | | |
| Isocyanate resin | 7.90 | 15.93 |
| Additive | 8.45 | 17.19 |
| Aluminum oxide powder | 18.13 | 10.03 |
| Aluminum trihydrate powder | 48.73 | 43.44 |
| Calcium carbonate powder | 16.79 | 13.41 |
| Total | 100.00 | 100.00 |

TABLE 5

| | Wt % | Vol % |
|---|---|---|
| Polyol Containing Component | | |
| Polyol resin | 10.63 | 22.07 |
| Sn-based catalyst | 0.10 | 0.21 |
| Additive | 5.35 | 9.75 |
| Expandable microspheres - 120° C. Onset | 0.72 | 1.38 |
| Aluminum oxide powder | 18.43 | 9.99 |
| Aluminum trihydrate powder | 64.77 | 56.60 |
| Total | 100.00 | 100.00 |
| Isocyanate Containing Component | | |
| Isocyanate resin | 7.90 | 15.93 |
| Additive | 8.45 | 17.19 |
| Aluminum oxide powder | 18.13 | 10.03 |
| Aluminum trihydrate powder | 48.73 | 43.44 |
| Calcium carbonate powder | 16.79 | 13.41 |
| Total | 100.00 | 100.00 |

### Example 3

### Conventional 2.3 W/m·K Silicone TIM

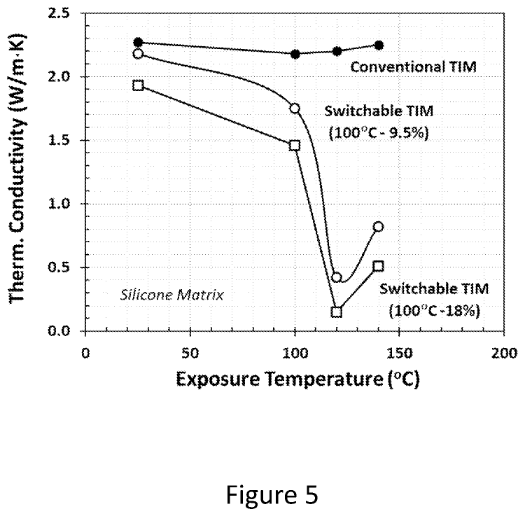

Table 6 lists ingredients of a conventional, thermally conductive, 2K silicone composition comprised of silicone/vinyl and a silicone vinyl/hydride containing components. Both components also contain thermally conductive aluminum trihydrate powder. The combination of the two components when mixed at a volumetric mix ratio of 1:1 and cured produce a material with a bulk thermal conductivity of 2.3 W/m·K. Exposure of the cured material to temperatures as high as 140° C. shows very little change in thermal conductivity as seen FIG. 5.

TABLE 6

| | Wt % | Vol % |
|---|---|---|
| Silicone Vinyl/Platinum Containing Component | | |
| Silicone vinyl resin | 14.52 | 29.32 |
| Pt-based catalyst | 0.18 | 0.35 |
| Additive | 2.71 | 3.49 |
| Aluminum trihydrate powder | 82.59 | 66.84 |
| Total | 100.00 | 100.00 |
| Silicone Vinyl/Hydride Containing Component | | |
| Silicone vinyl resin | 7.82 | 15.98 |
| Silicone hydride resin | 6.04 | 12.34 |
| Additive | 2.55 | 3.22 |
| Aluminum trihydrate powder | 83.59 | 68.46 |
| Total | 100.00 | 100.00 |

### Example 4

### Illustrative Examples of Nominally 2 W/m·K Switchable Silicone TIMs

Tables 7-8 list ingredients of switchable TIMs based on thermally conductive, 2K silicones compositions comprised of silicone/vinyl and a silicone vinyl/hydride containing components. Both components also contain expandable microspheres (100° C. onset temperature) and thermally conductive aluminum trihydrate powder. The combination of the two components when mixed at a volumetric mix ratio of 1:1 and cured produce a material with a bulk thermal conductivity of nominally 2 W/m·K. FIG. 5 shows the effect of exposure temperature on the bulk thermal conductivity for the TIMs of Tables 7 and 8. Unlike the conventional 2.3 W/m·K silicone (Table 6), the switchable TIM formulations show large drops (i.e. >63%) in the thermal conductivity when heated to 140° C. Moreover, the higher concentration of microspheres leads to a larger decrease in thermal conductivity when exposed to temperatures beyond 100° C.

TABLE 7

| | Wt % | Vol % |
|---|---|---|
| Silicone Vinyl/Platinum Containing Component | | |
| Silicone vinyl resin | 14.30 | 28.55 |
| Pt-based catalyst | 0.18 | 0.35 |
| Additive | 2.67 | 3.41 |
| Expandable microspheres - 100° C. Onset | 1.50 | 2.59 |
| Aluminum trihydrate powder | 81.35 | 65.10 |
| Total | 100.00 | 100.00 |
| Silicone Vinyl/Hydride Containing Component | | |
| Silicone vinyl resin | 7.70 | 15.55 |
| Silicone hydride resin | 5.95 | 12.01 |
| Additive | 2.51 | 3.13 |
| Expandable microspheres - 100° C. Onset | 1.50 | 2.67 |
| Aluminum trihydrate powder | 82.34 | 66.64 |
| Total | 100.00 | 100.00 |

TABLE 8

| | Wt % | Vol % |
|---|---|---|
| Silicone Vinyl/Platinum Containing Component | | |
| Silicone vinyl resin | 14.09 | 27.82 |
| Pt-based catalyst | 0.17 | 0.33 |
| Additive | 2.63 | 3.31 |
| Expandable microspheres - 100° C. Onset | 3.00 | 5.13 |
| Aluminum trihydrate powder | 80.11 | 63.41 |
| Total | 100.00 | 100.00 |
| Silicone Vinyl/Hydride Containing Component | | |
| Silicone vinyl resin | 7.58 | 15.12 |
| Silicone hydride resin | 5.86 | 11.69 |
| Additive | 2.48 | 3.06 |
| Expandable microspheres - 100° C. Onset | 3.00 | 5.28 |
| Aluminum trihydrate powder | 81.08 | 64.85 |
| Total | 100.00 | 100.00 |

### Example 5

### Conventional 3.5 W/m·K Silicone TIM

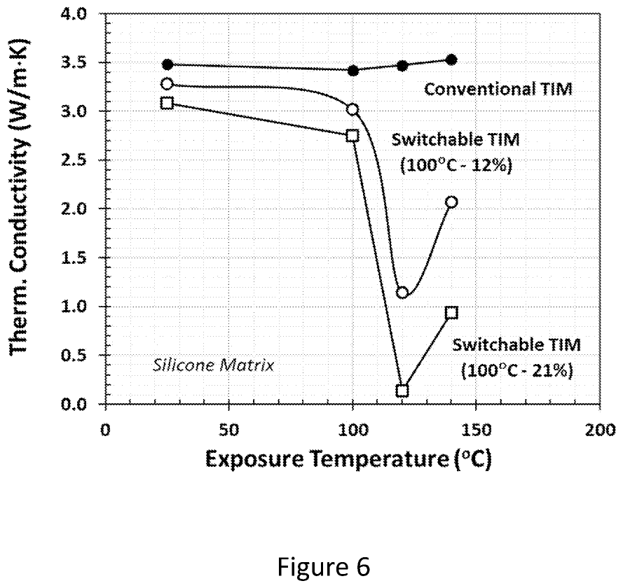

Table 9 lists ingredients of a conventional, thermally conductive, 2K silicone composition comprised of silicone/vinyl and a silicone vinyl/hydride containing components. Both components also contain thermally conductive aluminum trihydrate and zinc oxide powders. The combination of the two components when mixed at a volumetric mix ratio of 1:1 and cured produce a material with a bulk thermal conductivity of 3.5 W/m·K. Exposure of the cured material to temperatures as high as 140° C. shows very little change in thermal conductivity as seen FIG. 6.

TABLE 9

| | Wt % | Vol % |
|---|---|---|
| Silicone Vinyl/Platinum Containing Component | | |
| Silicone vinyl resin | 7.18 | 24.85 |
| Pt-based catalyst | 0.06 | 0.11 |
| Additive | 1.00 | 2.54 |
| Aluminum oxide powder | 67.01 | 57.66 |
| Zinc oxide powder | 24.75 | 14.84 |
| Total | 100.00 | 100.00 |
| Silicone Vinyl/Hydride Containing Component | | |
| Silicone vinyl resin | 4.74 | 16.41 |
| Silicone hydride resin | 2.49 | 8.62 |
| Additive | 0.91 | 2.42 |
| Aluminum oxide powder | 67.01 | 57.66 |
| Zinc oxide powder | 24.85 | 14.89 |
| Total | 100.00 | 100.00 |

### Example 6

### Illustrative Examples of Nominally 3.2 W/m·K Switchable Silicone TIMs

Tables 10-11 list ingredients of switchable TIMs based on thermally conductive, 2K silicones compositions comprised of silicone/vinyl and a silicone vinyl/hydride containing components. Both components also contain expandable microspheres (100° C. onset temperature) and thermally conductive aluminum trihydrate and zinc oxide powders. The combination of the two components when mixed at a volumetric mix ratio of 1:1 and cured produce a material with a bulk thermal conductivity of nominally 3.2 W/m·K. FIG. 6 shows the effect of exposure temperature on the bulk thermal conductivity for the TIMs of Tables 7 and 8. Unlike the conventional 3.5 W/m·K silicone (Table 9), the switchable TIM formulations show large drops (i.e. >36%) in the thermal conductivity when heated to 140° C. Moreover, the higher concentration of microspheres leads to a larger decrease in thermal conductivity when exposed to temperatures beyond 100° C.

TABLE 10

| | Wt % | Vol % |
|---|---|---|
| Silicone Vinyl/Platinum Containing Component | | |
| Silicone vinyl resin | 7.11 | 24.10 |
| Pt-based catalyst | 0.06 | 0.10 |
| Additive | 0.99 | 2.47 |
| Expandable microspheres - 100° C. Onset | 1.00 | 2.99 |
| Aluminum oxide powder | 66.34 | 55.95 |
| Zinc oxide powder | 24.50 | 14.39 |
| Total | 100.00 | 100.00 |
| Silicone Vinyl/Hydride Containing Component | | |
| Silicone vinyl resin | 4.70 | 15.92 |
| Silicone hydride resin | 2.47 | 8.36 |
| Additive | 0.90 | 2.34 |
| Expandable microspheres - 100° C. Onset | 1.00 | 2.99 |
| Aluminum oxide powder | 66.33 | 55.94 |
| Zinc oxide powder | 24.60 | 14.45 |
| Total | 100.00 | 100.00 |

TABLE 11

| | Wt % | Vol % |
|---|---|---|
| Silicone Vinyl/Platinum Containing Component | | |
| Silicone vinyl resin | 7.04 | 23.39 |
| Pt-based catalyst | 0.06 | 0.10 |
| Additive | 0.97 | 2.39 |
| Expandable microspheres - 100° C. Onset | 2.00 | 5.86 |
| Aluminum oxide powder | 65.67 | 54.29 |
| Zinc oxide powder | 24.26 | 13.97 |
| Total | 100.00 | 100.00 |
| Silicone Vinyl/Hydride Containing Component | | |
| Silicone vinyl resin | 4.65 | 15.45 |
| Silicone hydride resin | 2.44 | 8.12 |
| Additive | 0.89 | 2.26 |
| Expandable microspheres - 100° C. Onset | 2.00 | 5.86 |
| Aluminum oxide powder | 65.66 | 54.28 |
| Zinc oxide powder | 24.35 | 14.02 |
| Total | 100.00 | 100.00 |

1. A thermal interface material composition, comprising:
a two-component thermosetting matrix, wherein the two-component thermosetting matrix comprises a first component and a second component; and
a thermally conductive filler,
wherein the thermal interface material is thermally conductive at a first temperature range, wherein the thermal conductivity of the thermal interface material substantially decreases at a second temperature range.

2. The thermal interface material composition of claim 1, wherein the first component comprises a resin capable of reacting when in contact with the second component and optionally comprises a thermally conductive filler.

3. The thermal interface material composition of claim 1, wherein the first component comprises an isocyanate resin capable of reacting when in contact with the second component, and optionally comprises a thermally conductive filler.

4. The thermal interface material composition of claim 1, wherein the first component comprises a vinyl functional silicone resin and an addition cure catalyst capable of reacting when in contact with the second component, and optionally comprises a thermally conductive filler.

5. The thermal interface material composition of claim 1, wherein the first component comprises an epoxy resin capable of reacting when in contact with the second component, and optionally comprises a thermally conductive filler.

6. The thermal interface material composition of claim 1, wherein the first component comprises an acrylic resin capable of reacting when in contact with the second component, and optionally comprises a thermally conductive filler.

7. The thermal interface material composition of claim 1, wherein the second component comprises a compound capable of reacting with and/or initiating a polymerization of the reactive resin of the first component.

8. The thermal interface material composition of claim 1, wherein the second component comprises an isocyanate reactive compound capable of reacting with the composition of the first component.

9. The thermal interface material composition of claim 1, wherein the second component comprises a hydride functional silicone resin capable of reacting with the composition of the first component.

10. The thermal interface material composition of claim 1, wherein the second component comprises an epoxy reactive compound or catalyst capable of reacting with and/or initiating the polymerization of the epoxy resin of the first component.

11. The thermal interface material composition of claim 1, wherein the second component comprises an initiator capable of polymerizing the composition of the first component.

12. The thermal interface material composition of claim 1, wherein the first and second components are configured to be mixed to react to form a thermal interface matrix.

13. The thermal interface material composition of claim 1, wherein the first temperature range is from about −40° C. to about 80° C., wherein the second temperature range is from about 80° C. to about 200° C., optionally wherein the first temperature range is from about −40° C. to about 160° C., wherein the second temperature range is from about 160° C. to about 250° C.

14. The thermal interface material composition of claim 1, wherein the thermal interface material decreases thermal conductivity by at least about 30%, about 50%, about 75%, about 90%, about 95%, about 99%, or more.

15. The thermal interface material composition of claim 14, wherein the thermal interface material decreases in apparent conductivity, and/or increases interfacial resistance.

16. The thermal interface material composition of claim 1, wherein the apparent conductivity of the thermal interface material, upon exposure to the second temperature range, decreases by at least about 50%, about 75%, about 80%, about 90%, about 95%, about 99%, or more.

17. The thermal interface material composition of claim 1, further comprising a constituent capable of decomposing and/or changing phase at elevated temperature thereby reducing an apparent conductivity of the thermal interface material.

18. (canceled)

19. The thermal interface material composition of claim 1, further comprising expandable polymeric microspheres, or wherein the conductive filler comprises aluminum trihydrate (ATH).

20. A thermal interface material formed from the compositions of claim 1, the thermal interface material formed by mixing the first component with the second component.

21. A method of making a thermal interface material, the method comprising mixing the first component with the second component from claim 1.
